(19) United States
(12) Patent Application Publication
(10) Pub. No.: US 2026/0237624 A1
(43) Pub. Date: Aug. 13, 2026

(54) INTERFACE AND METHOD FOR THE PREPARATION OF MATERIAL FOR TRANSFER INTO A MASS SPECTROMETER

(71) Applicants: UNIVERSITE DE LILLE, LILLE (FR); INSTITUT NATIONAL DE LA SANTÉ ET DE LA RECHERCHE MÉDICALE, PARIS cedex 13 (FR); CENTRE HOSPITALIER UNIVERSITAIRE DE LILLE, LILLE (FR)

(72) Inventors: Philippe SAUDEMONT, Villeneuve d'Ascq (FR); Gwendal JOSSE, Toulouse (FR); Michel SALZET, Bourghelles (FR); Isabelle FOURNIER, Bourghelles (FR)

(73) Assignees: UNIVERSITE DE LILLE, LILLE (FR); INSTITUT NATIONAL DE LA SANTÉ ET DE LA RECHERCHE MÉDICALE, PARIS cedex 13 (FR); CENTRE HOSPITALIER UNIVERSITAIRE DE LILLE, LILLE (FR)

(21) Appl. No.: 19/156,594

(22) PCT Filed: Feb. 16, 2024
(86) PCT No.: PCT/FR2024/050209

§ 371 Date: Aug. 14, 2025

(30) Foreign Application Priority Data
Feb. 16, 2023 (FR) FR2301465

(51) Int. Cl. H01J 49/04; H01J 49/16

(52) U.S. Cl. CPC H01J 49/0468; H01J 49/045; H01J 49/168

(57) ABSTRACT

An interface for preparation of biological material for transfer thereof into a mass spectrometer. The interface includes a routing tube for the biological material in aerosol form, a Venturi system with two inlets and one outlet, a cartridge heater, a corona discharge needle for ionizing the biological material in aerosol form, a nebulizer for generating a mist and a transfer tube connected to the outlet of the Venturi system. The interface is arranged such that the cartridge heater is placed around the transfer tube, the corona discharge needle is located at the outlet of the transfer tube, and the Venturi system is connected to the routing tube for the biological material and to the nebulizer by two inlets leading to the solvation of the biological material in aerosol form by the mist in the Venturi system.

### FIELD

The present disclosure comes from the field of mass spectrometer interfaces. More specifically, an interface and a method for preparation of biological material for transfer thereof into a mass spectrometer.

### BACKGROUND

In any field of biology and medicine, the identification of specimens, whether they are in a physiological or a physio-pathological state, has a crucial importance in particular in connection with diagnosis, prognosis and treatment of illnesses.

For example, cancer is diagnosed based on information gathered by imaging methods. These imaging methods (e.g. CT-scan, MRI) may provide high-resolution images, but these high-resolution methods do not allow obtaining sufficient information in particular about the identification of malignant proliferations. Conversely, other methods (e.g. nuclear imaging techniques), whose images have a lower resolution, may instead provide information relevant to the proliferation of the disease. Generally, one or more of these imaging methods in combination must be used for identifying and locating cancer.

A precise diagnosis from pathological or abnormal tissue is generally obtained by histology, a branch of biology involving the study of biological tissues, or by cytology, a branch of biology involving the study of cells.

With these imaging and analysis methods, tissues which are pathological or have anomalies can be efficiently diagnosed. However, these methods do not make it possible to get information on the location of the malignant tissues during the surgical intervention.

One way to get around this problem is to perform a histopathological examination of removed tissue during the operation. It consists of performing an extemporaneous diagnosis and also observing whether the boundaries of the malignant tissue are well defined in the collected tissue. This method is very widespread despite various disadvantages, like time required (typically 20 to 50 minutes according to the cases and the facilities), all while keeping the patient in the operating room. Other methods are used like ultrasound and X-ray fluoroscope imaging. Despite useful results, these methods are not sufficiently sensitive to allow identification of the presence of a limited number of malignant cells.

The malignant tissues (i.e. tumor) can be distinguished from healthy tissue in several respects. In fact, the tumors have a very different molecular composition, ranging from the distribution of small metabolic constituents and lipids to the expression of different proteins. These molecular characteristics may be used for visualizing tumors by various imaging techniques including molecular imaging of the tissue by infrared spectrophotometry or mass spectrometry. Among these methods, mass spectrometry may serve as the basis for an in situ, in vivo tissue identification tool by analyzing the various molecular compositions of the various tissues.

The ionization methods by mass spectrometry were initially developed for analysis of gaseous or volatile materials. One of the disadvantages of these ionization methods is that they do not allow analyzing the nonvolatile compounds which represent about 90% of the molecules relevant to the analysis of the pathological tissues.

Starting in the 1940s, new methods for production of ions were developed making the production of gas phase ions directly from a solid sample possible. For the most part, these methods call on a desorption/ionization process. The methods of ionization by desorption use an analytic beam to promote desorption and ionization. The analytic beam comprises entities of various compositions (atoms, molecules, atomic or molecular ions, photons, etc.) which are directed onto the surface of the sample and sent with a variable energy level.

For example, the desorption/ionization method by accelerated atom bombardment (Fast Atom Bombardment (FAB)) uses high energy inert gas atoms to bombard the sample to be analyzed, allowing powdering and ionizing it; the secondary ion mass spectrometry (SIMS) method consists of bombarding the surface of the sample to be analyzed with a highly accelerated ion beam. The sample is then powdered, and a part of the powdered material is ionized. These techniques however have the disadvantage of requiring high vacuum conditions. The samples are therefore inserted into the high vacuum enclosure of the mass spectrometer, which involves significant restrictions on the composition and geometry of the samples, and also requires special systems for insertion thereof.

The need for ionization methods by desorption operating under atmospheric conditions was questioned. Operation at atmospheric pressure and more specifically under ambient conditions (Ambient Ionization Mass Spectrometry (AIMS)) has in particular advantages of a faster and more flexible analysis method as well as not having pre-treatments of samples like an extraction of compounds of interest. Further, biological systems, including living organisms, may be studied in vivo and in situ. All that allows the use of these methods (AIMS) for in situ tissue identification.

Among these methods under ambient conditions, the following methods may for example be cited: Rapid Evaporative Ionization Mass Spectrometry (REIMS) which uses a heated collision surface to produce ions from an aerosol; Extractive Atmospheric Pressure Photoionization (EAPPI) which uses a system of ultrasonic nebulization to nebulize and vaporize samples which are then mixed with a gaseous dopant and interact with photons and ambient medium to allow the gas-phase ionization of analytes; simple ionization by ultrasonic powdering under ambient conditions (Easy Ambient Sonic Spray Ionization: EASI) which uses a nebulized solvent flow directed against a surface, where the solvent interacts and carries away analytes by evaporation during which the analyte is ionized and released in gas phase; and Droplet Assisted Inlet Ionization (DAII) which brings aqueous droplets and particles in suspension in air into contact at their inlet into the mass spectrometer, where these droplets are heated and their rapid evaporation leads to the formation of molecular ions.

More recently, the Desorption Electrospray Ionization (DESI) method was developed. This method uses charged solvent droplets as analysis beam. The DESI method meets all the expectations associated with ambient ionization methods, and thus opened the scope of analysis by mass spectrometer to objects varied in terms of molecular composition, size and geometry.

The study of tissues by means of mass spectrometry was pursued in two fundamentally different ways. The first approach was oriented to the characterization-long, but also as exhaustive as possible-of molecules present in the tissue by strategies based on the extraction of particular compound families (metabolites, lipids, proteins, etc.) and coupling the mass spectrometry with separation methods (e.g. gas or liquid chromatography), whereas the second is concentrated on a rapid analysis without extraction or separation, similar to taking quick and direct molecular fingerprints.

Methods belonging to the first group generally start by homogenization and lysis of some quantity of tissue, followed by selective extraction of the group of compounds of interest. The compounds are separated by electrophoresis or chromatography, then analyzed by mass spectrometry. Even though these methods cannot be used for instantaneous identification of tissues, they provide precise information on the molecular markers characterizing of such and such tissue type, the variations of their relative abundance and the signaling pathways in which these molecules are involved.

The quick molecular printing of tissues by mass spectrometry is generally obtained by the methods described above and in particular the desorption/ionization methods (SIMS, MALDI) and AIMS.

The desorption and ionization of condensed-phase nonvolatile samples by using lasers have been sought since the end of the 1960s. Most of the laser desorption methods result in the formation of molecular aggregates of variable sizes and predominantly neutral; hence, these methods were often associated with post-ionization techniques. Post-ionization was traditionally done by Electron Impact (EI) or Chemical Ionization (CI). More recently, an approach was introduced using Electrospray Ionization (ESI) of gaseous species resulting from laser ablation of samples (Laser Ablation Electrospray Ionization (LAESI)). These methods however have the disadvantage either of not successfully fully breaking the molecular aggregates, or of not having ionization yields with which to get better sensitivity and depth of the signal analyzable by mass spectrometry.

There is therefore still a need to provide an appropriate interface for preparing the sample to be analyzed after collection and before transfer into a mass spectrometer (in particular at the mass analyzer) serving to break the molecular aggregates and improve the ionization of the molecules of the samples (i.e. post ionization).

### SUMMARY

The present disclosure aims to provide a solution to the situation.

According to a first aspect, an interface is proposed for preparation of material, in particular biological, for transfer thereof into a mass spectrometer, where the material is in aerosol form (neutral or partially ionized), the interface comprising:
a Venturi system with two inlets and one outlet,
a heater,
a corona discharge needle for ionizing the material in aerosol form, characterized in that the interface further comprises:
a nebulizer for generating a mist,
a transfer tube connected to the outlet of the Venturi system,
   and in that:
the heater is configured for heating the transfer tube,
the corona discharge needle is located at the outlet of the transfer tube, and
the Venturi system is configured for receiving the material in aerosol form by one of its inlets and is connected to the nebulizer by the other of its inlets leading to the solvation of the material in aerosol form by the mist in the Venturi system.

The interface, according to the first aspect of the invention, serves to break the molecular aggregates of material coming from the sample collection site into aerosol form and to ionize or improve the ionization yield of this material. In the Venturi system, connected to the nebulizer and to the routing tube, the material solvates into the droplets of the mist and desolvates when it passes through the transfer tube surrounded by the cartridge heater. This solvation-desolvation serves to disaggregate the molecules of material in order to improve the ionization done by the corona discharge. It is delivered by the corona discharge needle which is located downstream from the transfer tube. This improvement of the ionization, meaning the increase of the rate of conversion of molecules of neutral material into charged molecules, serves to increase the sensitivity of the analysis carried out by the mass spectrometer.

According to a second aspect, a method is proposed for material preparation, in particular biological, for transfer thereof into a mass spectrometer comprising:
routing the material in aerosol form towards a Venturi system,
   characterized in that the method further comprises:
injecting a mist comprising solvent droplets into the Venturi system,
solvating, in the Venturi system, the material in aerosol form into the solvent droplets of the mist,
heating the material solvated in the solvent droplets of the mist through a transfer tube connected to an outlet of the Venturi system, and
ionizing the material by a corona discharge delivered at the outlet of the transfer tube.

### BRIEF DESCRIPTION OF THE DRAWINGS

Other characteristics, details and advantages will appear upon reading the following detailed description, and upon analyzing the attached drawings, in which:

FIG. 1 shows a scheme of the interface according to the first aspect of the invention with the collinear routing flow of the material and outlet flow from the Venturi system.

FIG. 2 shows a scheme in partial section of the Venturi system and the nebulizer according to the first aspect of the invention.

FIG. 3 shows a scheme of the interface according to the first aspect of the invention with the collinear mist flow and outlet flow from the Venturi system.

FIG. 4 shows a schematic representation of the method according to the second aspect of the invention.

### DETAILED DESCRIPTION

### Interface 1

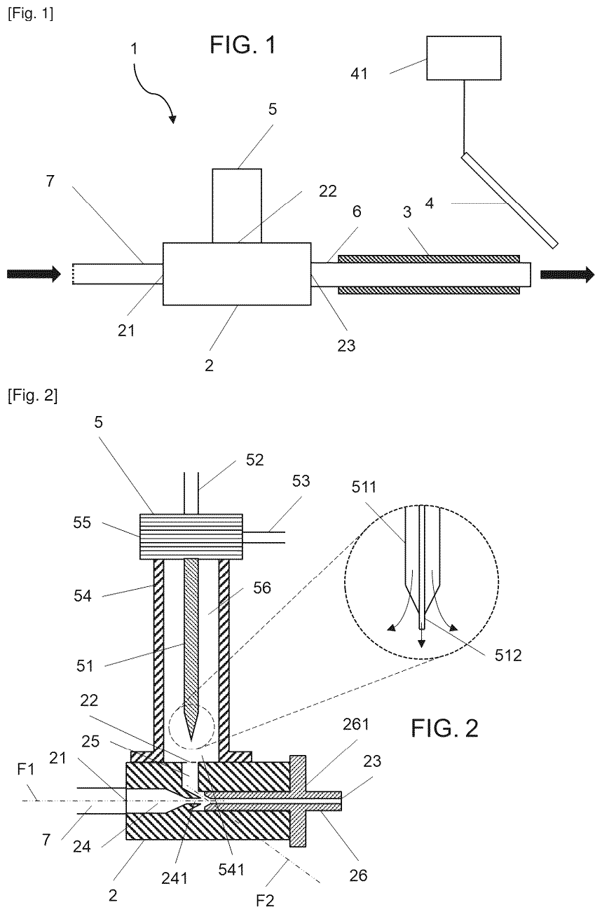

Now referring to FIG. 1 and FIG. 2.

According to a first aspect, an interface 1 is proposed by the present invention for preparation of material, in particular biological, for transfer thereof into a mass spectrometer, where the material is in aerosol form, the interface comprising:
a Venturi system 2 with two inlets 21, 22 and one outlet 23,
a heater 3,
a corona discharge needle 4 for ionizing the material in aerosol form, characterized in that the interface 1 further comprises:
a nebulizer 5 for generating a mist,
a transfer tube 6 connected to the outlet of the Venturi system 2, and in that:
the heater 3 is configured for heating the transfer tube 6,
the corona discharge needle 4 is located at the outlet of the transfer tube 6, and
the Venturi system 2 is configured for receiving the material in aerosol form by one of its inlets 21, 22 and is connected to the nebulizer 5 by the other of its inlets 21, 22 leading to the solvation of the material in aerosol form by the mist in the Venturi system 2.

The material which is ionized in the interface 1 comes in the form of particles, in particular particles of aggregated, ablated or desorbed biological tissue. Ablation or desorption may in particular be done by a laser. The biological tissues from which the biological material is collected may be any kind of tissue of biological origin with or without transformation like vegetable tissues (including cellulose-based materials), animal tissues, including human tissues (for example: nerve, muscular, epithelial or connective tissues), or even microorganisms (for example: bacteria, viruses, yeasts). The biological material is thus principally made up of aggregates of biomolecules (proteins, metabolites, lipids, etc.). They generally contain very little filler. As for nonbiological materials, the following can be cited: medications, xenobiotics, inorganic materials and metallic, organometallic or plastic compounds. Subsequently, the description will refer to biological materials. Nonetheless, the description also encompasses the case of nonbiological materials.

During ablation or desorption, some volume of material is ejected in gas phase. Thus, when the samples to be analyzed are collected, they are found in the form of an aerosol comprising solid particles, in particular aggregates of molecules of biological material, in a gaseous medium. This gaseous medium may in particular be a mixture comprising a gas which can be air, nitrogen, carbon dioxide, helium or other rare gases and water vapor.

The interface 1, according to the first aspect, comprises a nebulizer 5 allowing to generate a mist.

The nebulizer 5 is a unit with which to transform liquids into a cloud of extremely fine particles. With it, solutions and/or suspensions can be decomposed into an aerosol comprising droplets of the solution and/or the suspension. This aerosol is also called a mist; this term will be used subsequently.

The nebulizer 5 is a means with which to suspend a liquid in a gas. The nebulizer 5 may be selected from a compressor nebulizer, a mesh nebulizer, a jet nebulizer, a saturated vapor nebulizer and an ultrasonic nebulizer. A compressor nebulizer is a nebulizer using a flow of compressed gas to pull free droplets from a liquid and form a mist. A mesh nebulizer is nebulizer using a membrane perforated with small openings and vibrating, where the mist is created by forcing the liquid to pass through the membrane. A jet nebulizer is a nebulizer in which a liquid under pressure is forced through a very small opening to generate the mist. A saturated vapor nebulizer is a nebulizer in which a gas is passed through a heated or ambient temperature liquid, where the gas is loaded with vapor and droplets of this liquid in the form of a mist which is next brought to the outlet. An ultrasonic nebulizer is a nebulizer applying ultrasound to a liquid to make it vibrate at high frequencies, thus generating droplets of this liquid and forming the mist.

The nebulizer 5 may again be a nano-electronebulizer or a micro-electronebulizer. Preferably, the ionization device 2 is a nano-electronebulizer.

Subsequently, the description is given in connection with a compressor nebulizer, but it also applies to other types of nebulizers. The compressor nebulizer is the most commonly used type of nebulizer. It is also known under the name of atomizer. It generally comprises a means for routing a high-velocity compressed gas flow which is directed around a needle from which the liquid which is to be nebulized emerges. The passage of the gas leads to the formation of the mist by fragmentation of the liquid.

The compressor nebulizer 5 may comprise an emitter 51 from which is generated the mist, a solvent routing tube 52 and a gas routing tube 53. The solvent routing tube 52 and the gas routing tube 53 are connected to a socket 55 on a first side thereof and from which extends the emitter 51 from the other side opposite the first side.

The emitter 51 may comprise a tube 511 ending in a tip and a hollow needle 512. The tube 511 and the hollow needle 512 are coaxial. The tip of the hollow needle 512 extends past the tip of the tube 511. The solvent routing tube 52 is fluidly connected to the inside of the hollow needle 512, whereas the gas routing tube 53 is fluidly connected to the space between the tube 511 and the hollow needle 512. The tip of the tube 511 and the tip of the hollow needle 512 form the tip of the nebulizer 5 by which the mist is generated. The smaller the interior diameter of the hollow needle 512 is, the smaller the size of the droplets of the mist is. The needle generally has an interior diameter included between 50 and 200 μm. The emitter 51 is configured so that the flow rate of the mist generated at the outlet of the nebulizer 50 is included between 100 nL/minute and 2 mL/minute. In some cases, the flow rate may be from 100 nL/minute to 500 nL/minute. In other cases, the flow rate may be from 100 μL/minute to 2 mL/minute.

The solvent routing tube 52 serves to route the solvent to the nebulizer 5 and the gas routing tube 53 serves to route the gas to the nebulizer 5. The gas serves to spray the solvent in fine droplets in order to form the mist. The mist thus has the form of an aerosol of fine solvent droplets included in the gas which is routed by the gas routing tube 53.

The interface 1 may further comprise a nebulization connector 54 in which the nebulizer 5 is placed; the nebulization connector 54 comprises an outlet 541 connected to the Venturi system 2.

The nebulization connector 54 serves to partially receive the nebulizer 5 and to fluidly connect it with the Venturi system 2. The nebulization connector 54 preferably has a shape optimized for the effective transfer of the mist to the inside of the Venturi system 2; for example, the shape is conical (in particular the inner surface thereof) whose smallest section end is near the inlet to the Venturi system 2 and receives inside thereof the tube 511 and the hollow needle 512 of the nebulizer 5 and serving to concentrate the flow of mist to the inside of the Venturi system 2. The nebulization connector 54 extends from the bottom of the socket 55 of the nebulizer 5 and beyond the tip thereof, thus forming a nebulization chamber 56 between the tip and the end thereof.

The distance between the inlet 21, 22 of the Venturi system 2 and the tip of the nebulizer 5 may be included between 1 and 50 mm, preferably 2 and 10 mm, still preferably 3 and 5 mm.

The interface 1, according to the first aspect, comprises a Venturi system 2. The Venturi system 2 comprises two inlets 21, 22 and one outlet 23. The two inlets 21, 22 are connected to the routing tube 7 for the biological material and to the nebulizer 5. In the case where the interface 1 comprises the nebulization connector 54, it is the nebulization connector 54 which is connected to an inlet 21, 22 of the Venturi system 2 and not the nebulizer 5.

The mist generated by the nebulizer 5 is sent to the Venturi system 2. The flow of the mist serves to prime the Venturi system 2. A reduced pressure is created inside the Venturi system 2 and serves to aspirate the biological material in aerosol form into the inside of the Venturi system 2. Further, the mist also serves to break the aggregates of biological material in order to isolate the various molecules of biological material. These molecules of biological material solvate in the droplets of the mist.

The solvent routed by the solvent routing tube 52 is selected in such a way that the separation of the aggregates of biological material and also the solvation of the molecules of biological material in the droplets of solvent is effective. The solvent may be neutral towards the molecules of biological material. Since its main function is the solvation of the molecules of biological material, it is necessary that the solvent does not affect them in order to not alter the later analysis done by the mass spectrometer. However, there are cases where alteration of the molecules is desired. Thus, the solvent may be selected so as to alter the molecules of biological material and enhance the observation of certain species. The solvent may be selected from: an organic solvent; a volatile compound; polar molecules; nonpolar molecules; water; one or more alcohols (methanol, ethanol, isopropanol, propanol, butanol, pentanol); acetone; acetonitrile; tetrahydrofuran; ethyl acetate; ethylene glycol; dimethyl sulfoxide or dimethyl formamide; methyl-tert-butyl-ether; an aldehyde; a ketone; hexane; chloroform. In some embodiments, this solvent may include a supercharging agent, a lockmass (mass measurement compound) or calibration compound.

The compressed gas routed by the gas routing tube 53 is selected such that it does not have an impact on the biological material. Since the solvation is done between the molecules of biological material and the solvent droplets, the compressed gas must be neutral with respect to molecules of biological material in order to not alter them and therefore to not alter the mass spectrometry analysis.

However, in some cases, it is desirable that the gas interacts with molecules of the biological material and/or the solvent, for example ammonia for enhancing proton transfer.

The gas may be selected from molecular nitrogen and compressed air; preferably, the gas is molecular nitrogen.

The Venturi system 2 may comprise a routing connector allowing in particular receiving a routing tube 7 for the biological material in aerosol form. This routing tube 7 may be in the present interface. Alternatively, the routing tube is part of the laser sample collection equipment.

The routing tube 7 may have a cylindrical shape whose diameter is included between 1 and 12 mm, preferably between 1 and 8 mm, even between 1 and 5 mm. Preferably, the routing tube 7 is sufficiently long and flexible to be able to allow the operator to aspirate the ablated biological material whatever the operating zone and the difficulty of access thereof and so that the interface 1 and the mass spectrometer are not too close to the operating zone. The routing tube 7 may possibly be in contact with an open surgical incision; in this case, it is made of a material which may be sterilized and used in an operating room. Preferably, the routing tube 7 is made of a plastic or thermoplastic material selected from polycarbonate (PC), polypropylene (PP), polyethylene (PE), polyvinyl chloride (PVC), acrylonitrile butadiene styrene (ABS) or polytetrafluoroethylene (PTFE), for example.

The Venturi system 2 in particular has a shape such that, in operation, the flow coming from the routing tube 7 for the biological material and the flow coming from the nebulizer 5 are transverse, even orthogonal, to each other.

The orthogonality of the flows of biological material and mist allow in particular a better solvation of the biological material by the mist. Indeed, because the flows are orthogonal, a good probability of impact of the aggregates of biological material with the droplets of the mist is possible which serves to thus increase the separation of the aggregates of biological material. A larger proportion of molecules of biological material solvated in the droplets of mist serves to increase the proportion of molecules of biological material isolated.

The Venturi system 2 may have a T shape; alternatively, it may have a Y shape.

The T shape is characterized by two main axes. The Venturi system 2 may thus comprise a through-going longitudinal channel 24 with an inlet and an outlet corresponding respectively to one of the inlets 21 of the Venturi system 2 and to the outlet 23 thereof and a second channel 25 with one inlet corresponding to the other inlet 22 of the Venturi system 2 and connected to the through-going longitudinal channel 24, where the through-going longitudinal channel 24 and the second channel 25 are orthogonal to each other.

Alternatively, the Venturi system 2 has a shape such that, in operation, the flow coming from the routing tube for the biological material and the flow coming from the nebulizer 5 are transverse. Thus, the second channel may be transverse to the through-going longitudinal channel and in particular form an angle included between 20° and 120° with it, preferably between 30° and 110°, still more preferably 80° and 100°, for example 90°.

The destination of the inlets 21, 22 to the Venturi system 2 is not fixed. It is thus possible to interchange the various inlet flows between the two inlets 21, 22. The inlet 21 corresponds to one of the ends of the through-going longitudinal channel 24 and the inlet 22 to the end of the second channel 25.

The routing tube 7 and the nebulizer 5 may be arranged in such a way that, in operation, the flow leaving the Venturi system 2 is collinear with the flow coming from the routing tube 7 for the biological material.

In this configuration, the routing tube 7 is connected to the inlet 21 and the nebulizer 5 to the inlet 22 in particular by the nebulization connector 54 arranged in this area. This configuration corresponds to the interface 1 represented in FIGS. 1 and 2. In this configuration, the flow coming from the routing tube 7 is collinear with the through-going longitudinal channel 24 and the mist flow from the nebulizer 5 is collinear with the second channel 25 of the Venturi system 2.

The routing tube 7 and the nebulizer 5 may be arranged in such a way that, in operation, the flow leaving the Venturi system 2 is collinear with the flow coming from the nebulizer 5. In this configuration, the flow of biological material coming from the routing tube 7 is collinear with the second channel 25 of the Venturi system 2 and the flow coming from the nebulizer 5 is collinear with the through-going longitudinal channel 24.

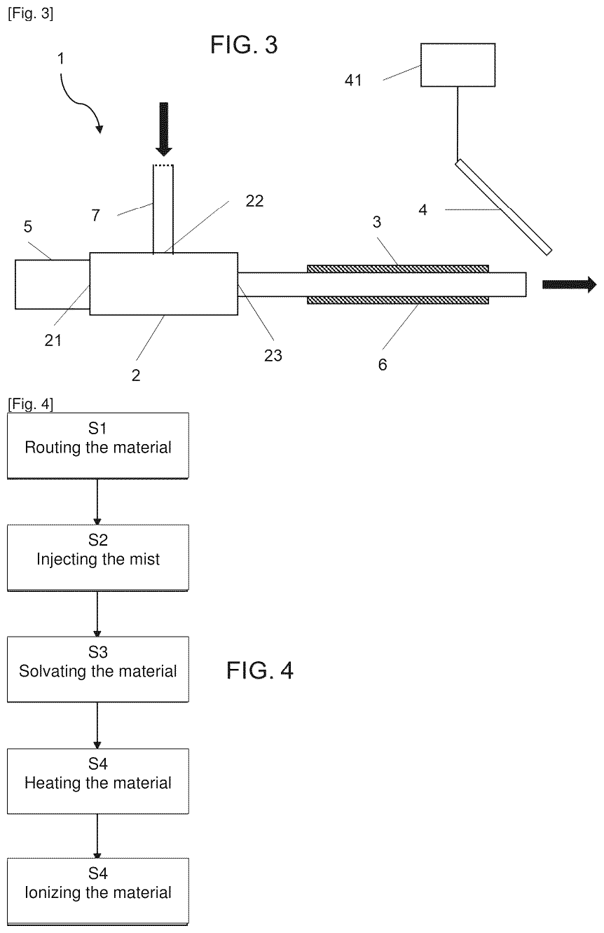

In this configuration, the nebulizer 5 is connected to the inlet 21 via in particular the nebulization connector 54 arranged in this area, and the routing tube 7 to the inlet 22. This configuration corresponds to the interface 1 represented in FIG. 3.

The through-going longitudinal channel 24 may have a first circular section at the inlet 21, a second section at the outlet 23 of the channel and a third circular section in the intermediate zone 241 between the inlet 21 and the outlet 23. The ratio between the third circular section and the first circular section may be included between 0.25 and 0.75, preferably 0.35 and 0.65, more particularly 0.5. The ratio between the third circular section and the second circular section may be included between 0.25 and 0.75, preferably 0.35 and 0.65, more particularly 0.5. The first section and the second section may be identical or different. In this latter case, the second section may be smaller or larger than the first section.

The intermediate zone 241 has a smaller circular section than the inlet 21 and the outlet 23 of the through-going longitudinal channel 24 of the Venturi system 2. It is this section difference which is the origin of the Venturi effect. This section difference leads to a lower pressure near the zone where the section is smaller. Since the routing tube 7 for the biological material has one end at atmospheric pressure, this reduced pressure leads to the aspiration of the biological material from the ablation zone. The smaller the ratio between the third circular section and the first or second circular section than the greater the reduction in pressure. Conversely, the flow speed near the intermediate zone 241 of the through-going longitudinal channel 24 is larger than that of the inlet 21 and the outlet 23 of the through-going channel 24. This increase of the flow speed supports a tendency to a more turbulent flow regime than at the inlet 21 or outlet 23 of the Venturi system 2 thus allowing improvement of the separation of the aggregates of biological material into isolated molecules of biological material and therefore the solvation of these molecules.

The second channel may connect with the intermediate zone of the through-going longitudinal channel.

The second channel of the Venturi system 2 may have a mist inlet system and an end portion for connection to the through-going longitudinal channel. The inlet portion has a longitudinal axis which is not collinear with that of the connection portion. In the following description relating to the angles formed by the through-going longitudinal channel and the second channel, the reference axis for the second channel is that of the inlet portion. Preferably, the longitudinal axis of the connection portion is configured so that the mist inlet flow F2 and the aerosol flow F3, near where they cross, form an acute angle, for example between 10 and 80°, preferably between 20 and 50°, still preferably between 25 and 40°, for example about 30°. This angle may advantageously correspond to the slope of the passage between the first section and the third section.

The Venturi system 2 may further comprise a part for adjustment of the aspiration 26 arranged in the through-going longitudinal channel near the outlet of the Venturi system 2.

The part for adjustment of the aspiration 26 may have a shape of a circular section whose outer diameter allows insertion thereof into the Venturi system 2. The part may have an annular protrusion 261 on the outer surface thereof forming a collar in order to block insertion of the aspiration adjustment part 26 by contact of the annular protrusion 261 against the corresponding edge of the outlet 23 of the Venturi system 2 thus providing the projection of the aspiration adjustment part 26 outside the Venturi system 2. This part for adjustment of the aspiration 26 may have a fourth circular section smaller than the second circular section in order to reduce the circular section near the outlet of the through-going longitudinal channel for adjusting the aspiration of the biological material by varying the low pressure created by the Venturi system 2.

The ratio between the fourth circular section and the second circular section may be included between 0.5 and 1.5, preferably between 0.5 and 0.89, still preferably 0.6 and 0.8, more particularly 0.7.

The Venturi system 20 may be made in whole or in part of a material selected from metal (e.g. stainless steel, titanium, brass, aluminum, or alloys thereof) or plastic (polyetheretherketone (PEEK), polytetrafluoroethylene (PTFE), perfluoroalkoxy (PFA), fluorinated ethylene-propylene (FEP), polylactic acid (PLA), acrylic nitrile butadiene styrene (ABS), polyethylene terephthalate glycol (PETG), or mixtures thereof).

The interface 1, according to the first aspect, comprises a transfer tube 6 connected to the outlet 23 of the Venturi system 2, a heater 3 configured for heating the transfer tube 6 and one or more corona discharge needles 4 (subsequently the singular is used) for ionizing the biological material in aerosol form leaving the outlet of the transfer tube 6.

The transfer tube 6 serves to transfer the biological material solvated in the solvent droplets on outlet 23 from the Venturi system 2 to the corona discharge needle 4. The transfer tube 6 is collinear with the through-going longitudinal channel of the Venturi system 2.

The transfer tube 6 may have a circular section whose diameter is included between 2 and 8 mm, preferably 2 and 5 mm, more particularly 3 mm. It may be made from materials selected from metal (stainless steel, titanium, brass, aluminum), glass or plastic resistant to high temperatures such as polyethyleneketone (PEEK) or polytetrafluoroethylene (PTFE).

The heater 3 may be a cartridge heater located around the transfer tube 6 serving to heat the biological material in solvated aerosol form to desolvate the biological material. The cartridge heater 3 may be configured for delivering a heat included between 40 and 500° C., preferably between 100 and 300° C., more specifically 250° C.

Alternatively, the cartridge heater 3 may be replaced by other heating types, such as heating internal to the transfer tube 6 (for example a grid heater), a microwave heater arranged around the transfer tube 3 or an ultrasonic disruptor.

At the outlet of the transfer tube 6, the corona discharge needle 4 serves to ionize the biological material in desolvated aerosol form by delivering a corona discharge. The corona discharge needle 4 is arranged such that the flow of desolvated biological material on outlet from the transfer tube 6 is transverse to the direction in which the corona discharge needle 4 points or parallel thereto, for example the angle formed by the of desolvated biological material and the plume of the plasma is from 0°to 90°, preferably 20°to 60°, still preferably between 40°to 50°. The corona discharge is thus delivered to the flow of desolvated biological material.

The corona discharge needle 4 may be composed conventionally of tungsten, but also be made up purely or of an alloy of one or more metals among silver, gold, platinum, iron, nickel and lithium with the goal of creating interactions with the gas phase analytes. This may serve to improve the detection quality of the analytes in particular by an improvement of the detection sensitivity.

The interface 1 may further comprise a current source 41 for supplying the corona discharge needle 4 in order to deliver the corona discharge, in particular at an absolute voltage included between 2 and 10 kV.

Since the molecules of biological material were previously separated from the aggregates of biological material in the Venturi system 2, the biological material desolvated by the heat provided by the heater 3 are mostly in the form of isolated molecules. This thus serves to improve the ionization achieved by the corona discharge from the corona discharge needle 4.

After ionization, the ionized molecules of biological material may be transferred to the mass spectrometer for analysis. The improvement of the ionization of the biological material by the interface serves in particular to increase the analysis signal from the mass spectrometer and therefore to improve the performance of the system by enhancing the identification of the molecules which are analyzed. Thus, the operator analyzing the signal is better able to identify the composition of the biological tissues and to identify the presence or absence of pathological or abnormal elements.

### Method

Now referring to FIG. 4.

According to a second aspect, the invention proposes a method for material preparation, in particular biological, for transfer thereof into a mass spectrometer comprising:
routing S1 the material in aerosol form towards a Venturi system, characterized in that the method further comprises:
injecting S2 a mist comprising solvent droplets into the Venturi system,
solvating S3, in the Venturi system, the material in aerosol form into the solvent droplets from the mist,
heating S4 the mixture of the solvated material in the solvent droplets from the mist by a heater located around a transfer tube connected to an outlet of the Venturi system leading to the desolvation of the material, and
ionizing S5 the material by a corona discharge delivered at the outlet of the transfer tube.

### Step S1

Step S1 comprises the routing of the biological material in aerosol form.

The biological material comes in the form of molecular aggregates as explained above.

The flow of biological material may have a flow rate included between 0.5 L/minute and 5 L/minute, preferably 1 L/minute.

The routing of the biological material may be done by a pressure difference generated by Venturi system.

Since the biological material in aerosol form is ablated or collected in a zone at atmospheric pressure, the pressure difference generated by the Venturi system serves to aspirate the biological material in aerosol form towards the Venturi system.

### Step S2

Step S2 comprises injection of a mist comprising solvent droplets into the Venturi system.

The mist is injected into the Venturi system. It serves to prime the Venturi system by creating the low-pressure with which to aspirate and route the biological material towards the Venturi system.

The mist comprising the solvent droplets may be generated by a nebulizer, preferably a compressor nebulizer. A compressor nebulizer sprays an aerosol comprising solvent droplets dispersed in a carrier gas. As previously explained, the carrier gas serves to generate the mist. The solvent may be selected from: one or more organic solvents; one or more volatile compounds; one or more polar molecules; one or more nonpolar molecules; water; and mixtures thereof. The following can be listed among the organic solvents: alcohols (methanol, ethanol, isopropanol, propanol, butanol, pentanol); acetone; acetonitrile; tetrahydrofuran; ethyl acetate; ethylene glycol; dimethyl sulfoxide; dimethylformamide; methyl-tert-butyl-ether; aldehydes; ketones; hexanes; chloroform. In some embodiments, this solvent may be made acidic or basic, include a supercharging agent, a lockmass or calibration compound.

The mist may be ejected at a flow rate included between 100 nL/minute and 2 mL/minute. In some cases, the flow rate may be from 100 nL/minute to 500 nL/minute. In other cases, the flow rate may be from 100 μL/minute to 2 mL/minute.

The rate of generation serves to adjust the low pressure created in the Venturi system to modify the speed of routing the biological material in aerosol form.

### Step S3

Step S3 comprises the solvation of the biological material in aerosol form into the solvent droplets of the mist in the Venturi system.

The flow of biological material in aerosol form and the flow of mist meet in the Venturi system. The impact of the two flows serves, as previously explained, to break the aggregates of biological material to isolate the various molecules of biological material. The isolated molecules are then solvated in the solvent droplets.

Step S3 may be done in such a way that the flow of the biological material and the flow of the mist are orthogonal to each other. Preferably, the inlet flow of mist F2 and the flow of aerosol F3, near where they cross, form an acute angle, for example between 10 and 80°, preferably between 20 and 50°, still preferably between 25 and 40°, for example about 30°. This angle may advantageously correspond to the slope of the passage between the first section and the third section.

As previously explained, the fact that these two flows are orthogonal serves to improve the conversion of the aggregates of biological material into solvated molecules of biological material by improving the separation of the aggregates into isolated molecules of biological material.

### Step S4

Step S4 comprises the heating of the solvated biological material in the solvent droplets from the mist by a heater configured for heating transfer tube connected to an outlet of the Venturi system leading to the desolvation of the biological material.

After the solvation of the molecules of biological material, the solvated biological material in the solvent droplets from the mist pass through a transfer tube. This transfer tube is heated by the heater which serves to heat the solvated molecules of biological material. The selection of the heating temperature has an impact on the proportion of molecules of biological material which are desolvated. Step S4 may be done at a temperature between 40 and 500° C., preferably 100 and 300° C.

More generally, the flow inside the transfer tube and the temperature may be selected so as to provide a heat transfer included between 50 and 300° C., preferably 250° C.

This temperature range serves to maximize the proportion of biological material which is desolvated during step S4. The proportion of desolvated material at the end of step S4 may be included between 60 and 100%, preferably between 90 and 100%.

### Step S5

Step S5 comprises the ionization of the biological material by a corona discharge delivered at the outlet of the transfer tube.

Following the desolvation of the molecules of biological material in step S4, the molecules of biological material are ionized by a corona discharge delivered by a corona discharge needle at the outlet of the transfer tube. The voltage at which the corona discharge is delivered has an impact on the proportion of desolvated molecules of biological material which are ionized. The corona discharge delivered may be included in the absolute between 2 and 8 kV, preferably 5 kV.

A corona discharge delivered at this voltage serves to maximize the proportion of molecules of biological material which are ionized during step S5.

At the outcome of step S5, the molecules of biological material are ionized and ready to be transferred to the mass spectrometer to be analyzed. The method, according to the second aspect of the invention, serves to improve the ionization of the molecules of biological material and, by extension, the quantity of signal analyzable by the mass spectrometer and therefore the quality of the analysis.

1-12. (canceled)

13. An interface for preparation of material, in particular biological, for transfer thereof into a mass spectrometer, where the material is in aerosol form, the interface comprising:
a Ventu An interface for preparation of material, in particular biological, for transfer ri system with two inlets and one outlet,
a heater,
a corona discharge needle for ionizing the material in aerosol form, wherein the interface further comprises:
a nebulizer for generating a mist,
a transfer tube connected to the outlet of the Venturi system, and in that:
the heater is configured for heating the transfer tube,
the corona discharge needle is located at the outlet of the transfer tube, and
the Venturi system is configured for receiving the material in aerosol form by one of its inlets and is connected to the nebulizer by the other of its inlets leading to the solvation of the material in aerosol form by the mist in the Venturi system.

14. The interface according to claim 13 further comprising a routing tube for the biological material in aerosol form and connected to the inlet of the Venturi system receiving it.

15. The interface according to claim 13,
wherein the nebulizer is a compressor nebulizer, and the compressor nebulizer further comprises an emitter from which is generated the mist, a solvent routing tube and a gas routing tube.

16. The interface according to claim 13,
further comprising a nebulization connector in which the nebulizer is placed and the nebulization connector comprises an outlet connected to the Venturi system.

17. The interface according to claim 13,
wherein, in operation, the flow coming from the routing tube for the biological material and the flow coming from the nebulizer are orthogonal or transverse to each other.

18. The interface according to claim 13,
wherein, in operation, the flow leaving the Venturi system is collinear with the flow coming from the nebulizer.

19. The interface according to claim 13,
further comprising a current source for supplying the corona discharge needle, in particular at a potential difference included between 2 and 8 kV.

20. The interface according to claim 13,
wherein the cartridge heater is configured for delivering heat at a temperature included between 40 and 500° C., preferably between 100 and 300° C.

21. A method for material preparation, in particular biological, for transfer thereof into a mass spectrometer comprising:
routing the material in aerosol form towards a Venturi system, wherein the method further comprises:
injecting a mist comprising solvent droplets into the Venturi system,
solvating, in the Venturi system, the material in aerosol form into the solvent droplets from the mist,
heating the mixture of the solvated material in the solvent droplets from the mist by a heater located around a transfer tube connected to an outlet of the Venturi system leading to the desolvation of the material, and
ionizing the material by a corona discharge delivered at the outlet of the transfer tube.

22. The method according to claim 21,
wherein the mist is ejected from the nebulizer at a flow rate included between 100 nL/minute and 2 mL/minute or between 100 μL/minute to 2 mL/minute.

23. The method according to claim 21,
wherein step is done at a temperature included between 40 and 500° C., preferably 100 and 300° C.

24. The method according to claim 21,
wherein the corona discharge delivered is included between 2 and 10 kV, preferably 5 kV.
